(19) United States
(12) Patent Application Publication
(10) Pub. No.: US 2026/0179220 A1
(43) Pub. Date: Jun. 25, 2026

(54) STENT DETECTION AND GROUPING FOR POST PERCUTANEOUS INTERVENTION INTRAVASCULAR IMAGING

(71) Applicant: Boston Scientific Scimed, Inc., Maple Grove, MN (US)

(72) Inventors: Viola Kim Holman Narveson, Crystal, MN (US); Greta O'Brien, Austin, TX (US); Achala Thippeswamy, San Francisco, CA (US)

(73) Assignee: Boston Scientific Scimed, Inc., Maple Grove, MN (US)

(21) Appl. No.: 19/365,771

(22) Filed: Oct. 22, 2025

Related U.S. Application Data
(60) Provisional application No. 63/710,500, filed on Oct. 22, 2024.

(51) Int. Cl. G06T 7/00; G06T 7/12

(52) U.S. Cl. CPC G06T 7/0012; G06T 7/12; G06T 2207/10132; G06T 2207/30048; G06T 2207/30101

(57) ABSTRACT

The present disclosure provides to process intravascular images, such as intravascular ultrasound (IVUS) image frames, to detect stents represented in the images and to group detected stents into stent segments. The grouped stent segments can be visually represented as part of a graphical user interface (GUI) and a user can navigate through the stent segments via the GUI to review stent assessment information on a per stent segment basis.

### CROSS REFERENCE TO RELATED APPLICATIONS

This application claims the benefit of priority under 35 U.S.C. § 119 to U.S. Provisional Patent Application No. 63/710,500, filed October 22, 2024, each of which is herein incorporated by reference in its entirety.

### TECHNICAL FIELD

The present disclosure generally relates to intravascular imaging devices and systems arranged to capture a series of image frames and to graphical user interfaces to display indications of the captured image frames. Particularly, but not exclusively, the present disclosure relates to identifying stents from the captured image frames, grouping the stents into stent segments, and allowing a user to select a stent or stent segment for assessment.

### BACKGROUND

Intravascular imaging (IVI) devices are insertable into a patient's vasculature and configured to capture images from within the vessel lumen. Two common intravascular imaging modalities are intravascular ultrasound (IVUS) and optical coherence tomography (OCT). Such imaging modalities have proven diagnostic capabilities for a variety of diseases and disorders. For example, IVI devices are often used as part of a percutaneous coronary intervention (PCI) and can be used to plan, treat, and assess treatment for various obstructive coronary artery diseases, such as, unstable angina, acute myocardial infarction (MI), coronary artery disease (CAD), or the like.

As noted, an example IVI system is an IVUS system. An IVUS system includes a control module with a pulse generator, a motor drive unit, image acquisition and processing components, and a monitor. The IVUS system further includes a catheter with an ultrasound transducer included as part of the distal end of the catheter. The catheter is positioned in a lumen or cavity within, or in proximity to, a region to be imaged, such as a cardiac vessel. Often, a series of images or series of image frames are captured while the catheter is moved (e.g., pulled proximally, or the like) within the vessel lumen.

This series of image frames represent the vessel lumen structure (e.g., vessel wall, lumen, plaque, stents, etc.) along a longitudinal section of the vessel. Such images can be captured as part of a pre-PCI procedure to aid a physician in determining how to treat the patient, for example, what stent size is appropriate to treat a stenosis, stent landing zones, or the like. Further, such images can be captured as part of a post-PCI procedure to assess the results of the procedure, such as the placement and/or expansion of the stent.

However, it can be difficult for physicians to visualize the complete structure of the vessel lumen and/or the effectiveness of the PCI from the raw series of image frames. For example, it is difficult for physicians to identify key locations within an IVUS run. These key locations are often used as the basis for calculations and/or determinations related to making clinical decisions as part of a post-PCI procedure. This difficulty is compounded where multiple stents are disposed in the cardiac artery.

Thus, there here is a need for IVI systems and methods to process, annotate, visualize, and/or display images captured by IVI systems as part of a post-PCI procedure to assist physicians in making clinical decisions. Particularly, there is a need for detecting and grouping stents from IVI image data.

### BRIEF SUMMARY

This Summary is provided to introduce a selection of concepts in a simplified form that are further described below in the Detailed Description. This Summary is not intended to necessarily identify key features or essential features of the claimed subject matter, nor is it intended as an aid in determining the scope of the claimed subject matter.

In general, the present disclosure provides systems and techniques to detect stents from a series of image frames captured via an IVI modality as part of a post-PCI procedure and to group the stents. Specifically, the present disclosure provides systems and techniques to detect stents from post-PCI IVI imaging modality runs that have multiple stents within the imaged region. The detected stents can be grouped into stent segments (e.g., comprising one or more stents). Further, the stent segment groups can be presented for a user (e.g., physician, or the like) via a graphical user interface (GUI) and the user can select a stent segment for assessment (e.g., identification of key frames, derivation of stent expansion ratio, or the like). The selected stent segment and the associated assessments may allow users to quickly evaluate the stent placement and make clinical decisions to improve patient outcomes related to the post-PCI procedure.

Of note, the present disclosure provides systems and techniques to display visual representations of stents detected from a series of image frames captured via an IVI imaging modality in a graphical user interface (GUI). The detected and displayed stents can be grouped into stent segments based on the proximity of one stent to another stent. The systems and techniques further provide that a user can select a stent segment (or navigate between stent segments) via the GUI and stent assessments (e.g., detection of key frames, derivation of stent expansion ratio, or the like) can be automatically applied to the selected stent segment.

In some embodiments, the disclosure can be implemented as a computer-implemented method for an intravascular image navigation system. The computer-implemented method can comprise receiving, at a processor, a series of intravascular image (IVI) frames captured along a section of a cardiac artery of a patient where at least a first stent and a second stent are disposed in the section of the cardiac artery; determining, by the processor, whether a distance between an edge of the first stent and an edge of the second stent is less than or equal to a threshold value, wherein the edge of the first stent is adjacent to the edge of the second stent; and grouping, by the processor, the first stent and the second stent into a first stent segment if the distance between the edge of the first stent and the edge of the second stent is less than or equal to the threshold value; or grouping, by the processor, the first stent into the first stent segment and the second stent into a second stent segment if the distance between the edge of the first stent and the edge of the second stent is not less than or equal to the threshold value, and wherein the first stent segment and the second stent segment are stent segments of one or more stent segments.

With some embodiments of the computer-implemented method, a third stent is disposed in the section of the cardiac artery, the second stent is disposed between the first stent and the third stent, the first stent and the second stent are grouped into the first stent segment, and the method can comprise determining, by the processor, whether a distance between an edge of the second stent and an edge of the third stent is less than or equal to the threshold value, wherein the edge of the second stent is adjacent to the edge of the third stent; grouping, by the processor, the third stent into the first stent segment if the distance between the edge of the second stent and the edge of the third stent is less than or equal to the threshold value; or grouping, by the processor, the third stent into the second stent segment if the distance between the edge of the second stent and the edge of the third stent is not less than or equal to the threshold value.

With some embodiments of the computer-implemented method, a third stent is disposed in the section of the cardiac artery, the second stent is disposed between the first stent and the third stent, the first stent is grouped into the first stent segment and the second stent is grouped into the second stent segment, and the method can comprise determining, by the processor, whether a distance between an edge of the second stent and an edge of the third stent is less than or equal to the threshold value, wherein the edge of the second stent is adjacent to the edge of the third stent; grouping, by the processor, the third stent into the second stent segment if the distance between the edge of the second stent and the edge of the third stent is less than or equal to the threshold value; or grouping, by the processor, the third stent into a third stent segment if the distance between the edge of the second stent and the edge of the third stent is not less than or equal to the threshold value, wherein the third stent segment is a stent segment of the one or more stent segments.

With some embodiments, the computer-implemented method can comprise generating, by the processor, one or more graphical indications representing at least the first stent and the second stent, and the one or more stent segments; and sending, by the processor, one or more information elements to a display to cause the display to display the one or more graphical indications as part of a graphical user interface (GUI).

With some embodiments of the computer-implemented method, the threshold value is a first threshold value, the first stent and the second stent are grouped into the first stent segment, and the method can comprise determining, by the processor, whether the distance between the edge of the first stent and the edge of the second stent is less than or equal to a second threshold value; and wherein the first stent segment represented by the one or more graphical indications visually depicts the first stent and the second stent as one stent if the distance between the edge of the first stent and the edge of the second stent is less than or equal to the second threshold value, or wherein the first stent segment represented by the one or more graphical indications visually depicts the first stent and the second stent as individual stents if the distance between the edge of the first stent and the edge of the second stent is not less than or equal to the second threshold value.

With some embodiments, the computer-implemented method can comprise designating the first stent segment as an active stent segment, wherein the first stent segment represented by the one or more graphical indications is visually depicted as selected.

With some embodiments, the computer-implemented method can comprise receiving, at the processor, an indication to designate the second stent segment as the active stent segment, regenerating, by the processor, the one or more graphical indications representing at least the first stent and the second stent, and the one or more stent segments; and sending, by the processor, one or more information elements to the display to cause the display to display the regenerated one or more graphical indications as part of the GUI, wherein the second stent segment represented by the regenerated one or more graphical indications is visually depicted as selected.

With some embodiments of the computer-implemented method, the indication to select the second stent segment as the active stent segment is received via the GUI.

With some embodiments, the computer-implemented method can comprise determining, by the processor, whether the first stent segment includes the distal most complete stent; and designating, by the processor, the first stent segment as the active stent segment if the first stent segment includes the distal most complete stent.

With some embodiments, the computer-implemented method can comprise determining, by the processor, assessments based on an assessment process for the active stent segment, wherein the one or more graphical indications further represent the assessments for the active stent segment.

With some embodiments of the computer-implemented method, the second threshold distance is 2.0 millimeters (mm) or wherein the second threshold distance is between 1.5 millimeters (mm) and 2.5 mm.

With some embodiments of the computer-implemented method, the threshold distance is 5.0 millimeters (mm) or wherein the threshold distance is between 3.5 millimeters (mm) and 6.5 mm.

With some embodiments of the computer-implemented method, the series of IVI frames and intravascular ultrasound (IVUS) frames.

In some embodiments, the disclosure can be implemented as an apparatus, comprising a processor coupled to a memory, the memory comprising instructions executable by the processor, the processor configured to couple to an intravascular imaging (IVI) system and configured to execute the instructions, which instructions when executed cause the processor to implement any of the methods disclosed herein.

In some embodiments, the disclosure can be implemented as at least one non-transitory machine readable storage device, comprising a plurality of instructions that in response to being executed by a processor of an intravascular imaging (IVI) system cause the processor to implement any of the methods disclosed herein.

In some embodiments, the disclosure can be implemented as an intravascular image navigation system. The intravascular image navigation system can comprise a processor; and a memory storage device coupled to the processor, the memory storage device comprising instructions executable by the processor, which instructions when executed cause the intravascular image navigation system to receive a series of intravascular image (IVI) frames captured along a section of a cardiac artery of a patient where at least a first stent and a second stent are disposed in the section of the cardiac artery; determine whether a distance between an edge of the first stent and an edge of the second stent is less than or equal to a threshold value, wherein the edge of the first stent is adjacent to the edge of the second stent; and group the first stent and the second stent into a first stent segment if the distance between the edge of the first stent and the edge of the second stent is less than or equal to the threshold value; or group the first stent into the first stent segment and the second stent into a second stent segment if the distance between the edge of the first stent and the edge of the second stent is not less than or equal to the threshold value, and wherein the first stent segment and the second stent segment are stent segments of one or more stent segments.

With some embodiments of the intravascular image navigation system, a third stent is disposed in the section of the cardiac artery, the second stent is disposed between the first stent and the third stent, the first stent and the second stent are grouped into the first stent segment, and the memory storage device can comprise instructions executable by the processor, which instructions when executed cause the intravascular image navigation system to determine whether a distance between an edge of the second stent and an edge of the third stent is less than or equal to the threshold value, wherein the edge of the second stent is adjacent to the edge of the third stent; group the third stent into the first stent segment if the distance between the edge of the second stent and the edge of the third stent is less than or equal to the threshold value; or group the third stent into the second stent segment if the distance between the edge of the second stent and the edge of the third stent is not less than or equal to the threshold value.

With some embodiments of the intravascular image navigation system, a third stent is disposed in the section of the cardiac artery, the second stent is disposed between the first stent and the third stent, the first stent is grouped into the first stent segment and the second stent is grouped into the second stent segment, and the memory storage device can comprise instructions executable by the processor, which instructions when executed cause the intravascular image navigation system to determine whether a distance between an edge of the second stent and an edge of the third stent is less than or equal to the threshold value, wherein the edge of the second stent is adjacent to the edge of the third stent; group the third stent into the second stent segment if the distance between the edge of the second stent and the edge of the third stent is less than or equal to the threshold value; or group the third stent into a third stent segment if the distance between the edge of the second stent and the edge of the third stent is not less than or equal to the threshold value, wherein the third stent segment is a stent segment of the one or more stent segments.

With some embodiments of the intravascular image navigation system, the memory storage device can comprise instructions executable by the processor, which instructions when executed cause the intravascular image navigation system to generate one or more graphical indications representing at least the first stent and the second stent, and the one or more stent segments; and send one or more information elements to a display to cause the display to display the one or more graphical indications as part of a graphical user interface (GUI).

With some embodiments of the intravascular image navigation system, the threshold value is a first threshold value, the first stent and the second stent are grouped into the first stent segment, and the memory storage device can comprise instructions executable by the processor, which instructions when executed cause the intravascular image navigation system to determine whether the distance between the edge of the first stent and the edge of the second stent is less than or equal to a second threshold value; and wherein the first stent segment represented by the one or more graphical indications visually depicts the first stent and the second stent as one stent if the distance between the edge of the first stent and the edge of the second stent is less than or equal to the second threshold value, or wherein the first stent segment represented by the one or more graphical indications visually depicts the first stent and the second stent as individual stents if the distance between the edge of the first stent and the edge of the second stent is not less than or equal to the second threshold value.

With some embodiments of the intravascular image navigation system, the memory storage device can comprise instructions executable by the processor, which instructions when executed cause the intravascular image navigation system to designate the first stent segment as an active stent segment, wherein the first stent segment represented by the one or more graphical indications is visually depicted as selected.

With some embodiments of the intravascular image navigation system, the memory storage device can comprise instructions executable by the processor, which instructions when executed cause the intravascular image navigation system to receive an indication to designate the second stent segment as the active stent segment, regenerate the one or more graphical indications representing at least the first stent and the second stent, and the one or more stent segments; and send one or more information elements to the display to cause the display to display the regenerated one or more graphical indications as part of the GUI, wherein the second stent segment represented by the regenerated one or more graphical indications is visually depicted as selected.

With some embodiments of the intravascular image navigation system, the indication to select the second stent segment as the active stent segment is received via the GUI.

With some embodiments of the intravascular image navigation system, the memory storage device can comprise instructions executable by the processor, which instructions when executed cause the intravascular image navigation system to determine whether the first stent segment includes the distal most complete stent; and designate the first stent segment as the active stent segment if the first stent segment includes the distal most complete stent.

With some embodiments of the intravascular image navigation system, the memory storage device can comprise instructions executable by the processor, which instructions when executed cause the intravascular image navigation system to determine assessments based on an assessment process for the active stent segment, wherein the one or more graphical indications further represent the assessments for the active stent segment.

With some embodiments of the intravascular image navigation system, the second threshold distance is 2.0 millimeters (mm) or wherein the second threshold distance is between 1.5 millimeters (mm) and 2.5 mm.

With some embodiments of the intravascular image navigation system, the threshold distance is 5.0 millimeters (mm) or wherein the threshold distance is between 3.5 millimeters (mm) and 6.5 mm.

With some embodiments of the intravascular image navigation system, the series of IVI frames and intravascular ultrasound (IVUS) frames.

In some embodiments, the disclosure can be implemented as at least one non-transitory machine readable storage devices, comprising instructions that in response to being executed by a processor of an intravascular imaging (IVI) system cause the IVI system to receive a series of intravascular image (IVI) frames captured along a section of a cardiac artery of a patient where at least a first stent and a second stent are disposed in the section of the cardiac artery; determine whether a distance between an edge of the first stent and an edge of the second stent is less than or equal to a threshold value, wherein the edge of the first stent is adjacent to the edge of the second stent; and group the first stent and the second stent into a first stent segment if the distance between the edge of the first stent and the edge of the second stent is less than or equal to the threshold value; or group the first stent into the first stent segment and the second stent into a second stent segment if the distance between the edge of the first stent and the edge of the second stent is not less than or equal to the threshold value, and wherein the first stent segment and the second stent segment are stent segments of one or more stent segments.

With some embodiments of the at least one non-transitory machine readable storage devices, a third stent is disposed in the section of the cardiac artery, the second stent is disposed between the first stent and the third stent, the first stent and the second stent are grouped into the first stent segment, and the storage devices can comprise instructions that in response to being executed by the processor of the IVI system cause the IVI system to determine whether a distance between an edge of the second stent and an edge of the third stent is less than or equal to the threshold value, wherein the edge of the second stent is adjacent to the edge of the third stent; group the third stent into the first stent segment if the distance between the edge of the second stent and the edge of the third stent is less than or equal to the threshold value; or group the third stent into the second stent segment if the distance between the edge of the second stent and the edge of the third stent is not less than or equal to the threshold value.

With some embodiments of the at least one non-transitory machine readable storage devices, a third stent is disposed in the section of the cardiac artery, the second stent is disposed between the first stent and the third stent, the first stent is grouped into the first stent segment and the second stent is grouped into the second stent segment, and the storage devices can comprise instructions that in response to being executed by the processor of the IVI system cause the IVI system to determine whether a distance between an edge of the second stent and an edge of the third stent is less than or equal to the threshold value, wherein the edge of the second stent is adjacent to the edge of the third stent; group the third stent into the second stent segment if the distance between the edge of the second stent and the edge of the third stent is less than or equal to the threshold value; or group the third stent into a third stent segment if the distance between the edge of the second stent and the edge of the third stent is not less than or equal to the threshold value, wherein the third stent segment is a stent segment of the one or more stent segments.

With some embodiments of the at least one non-transitory machine readable storage devices, the storage devices can comprise instructions that in response to being executed by the processor of the IVI system cause the IVI system to generate one or more graphical indications representing at least the first stent and the second stent, and the one or more stent segments; and send one or more information elements to a display to cause the display to display the one or more graphical indications as part of a graphical user interface (GUI).

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1A illustrates an example cardiac vasculature structure with a stent placed in one of the cardiac arteries and an IVUS catheter inserted into the one of the cardiac arteries.

FIG. 1B illustrates an IVUS imaging system including the IVUS catheter shown in FIG. 1A.

FIG. 2A illustrates an example series of IVUS image frames.

FIG. 2B illustrates a longitudinal representation of the example series of IVUS image frames of FIG. 2A.

FIG. 3 illustrates an IVUS navigation system.

FIG. 4 illustrates a logic flow to group detected stents into stent segments and navigate through the stent segments via a graphical user interface (GUI) for a post-PCI procedure.

FIG. 5 illustrates a logic flow to group stents into stent segments in more detail.

FIG. 6 illustrates a logic flow to generate graphical indications for stents in stent segments in more detail.

FIG. 7 illustrates a graphical user interface.

FIG. 8 illustrates another graphical user interface.

FIG. 9 illustrates yet another graphical user interface.

FIG. 10 illustrates a graphical user interface that can include the graphical user interfaces of FIG. 7, FIG. 8 and/or FIG. 9.

FIG. 11 illustrates a computer-readable storage medium.

FIG. 12 illustrates a diagrammatic representation of a machine.

### DETAILED DESCRIPTION

The foregoing has broadly outlined the features and technical advantages of the present disclosure such that the following detailed description of the disclosure may be better understood. It is to be appreciated by those skilled in the art that the embodiments disclosed may be readily utilized as a basis for modifying or designing other structures for carrying out the same purposes of the present disclosure. The novel features of the disclosure, both as to its organization and operation, together with further objects and advantages will be better understood from the following description when considered in connection with the accompanying figures. It is to be expressly understood, however, that each of the figures is provided for the purpose of illustration and description and is not intended as a definition of the limits of the present disclosure.

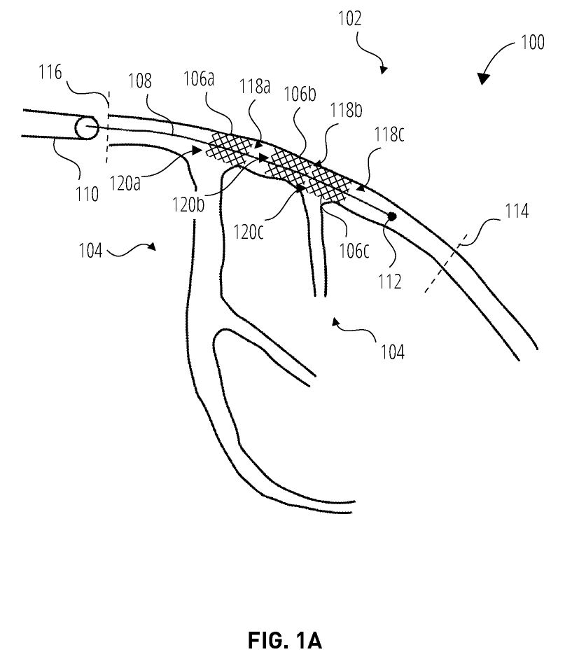

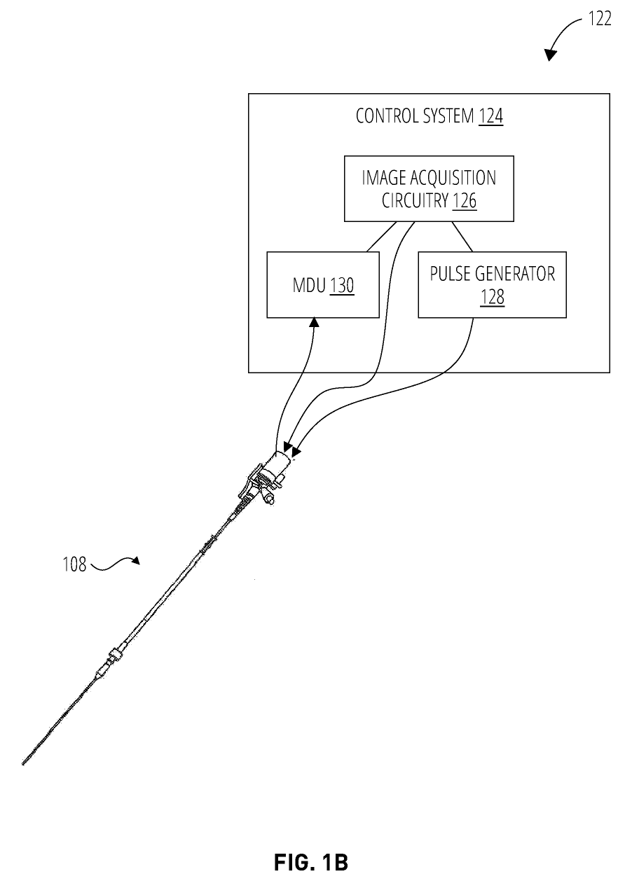

As outlined above, after some PCI procedures where a stent or stents are placed in a section of a patient's vasculature, a post-PCI procedure can be performed. The post-PCI procedure is typically performed so that physicians can assess the placement of the stent(s), the expansion of the stent(s), and/or other characteristics of the PCI procedure. FIG. 1A illustrates a cardiac vasculature structure 100 having a cardiac artery 102 (e.g., cardiac artery, vessel, or the like) with several side branches 104 (e.g., descending arteries, marginal arteries, vessels, or the like) branching off the cardiac artery 102. The cardiac vasculature structure 100 further depicts stents 106a, 106b, and 106c disposed (or placed) in portions of the cardiac artery 102. It will be appreciated that the stents 106a, 106b, and/or 106c may be placed as part of a PCI procedure (or multiple procedures) to treat a stenosis in the cardiac artery 102. That is, stents 106a, 106b, and 106c can be placed as part of PCI procedure(s) (e.g., stenting balloon dilation, stenting with atherectomy, or the like) intended to dilate or open blocked or partially occluded vessels. In some examples, ones of the stents 106a, 106b, and/or 106c can be drug-eluting.

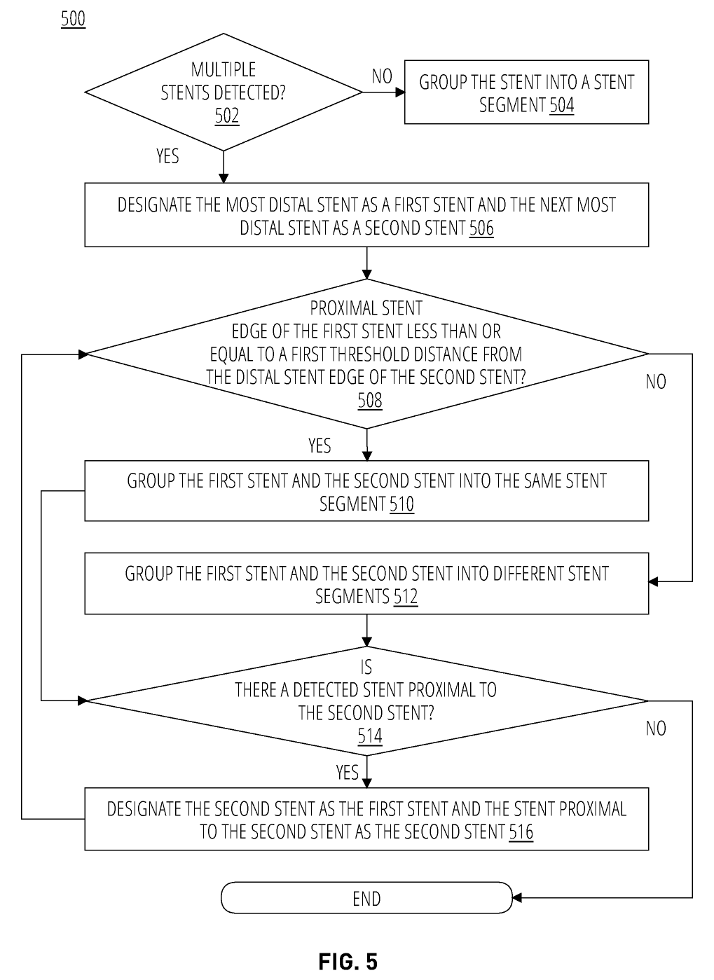

As noted above, PCI procedures can be guided by intravascular imaging. For example, prior to performing a PCI procedure, during a PCI procedure, and/or after a PCI procedure; an intravascular imaging catheter (e.g., IVUS imaging catheter 108) is inserted into the cardiac artery 102 via a guide catheter 110 and images of the cardiac artery 102 are captured. The IVUS imaging catheter 108 includes an ultrasound transducer 112 disposed on a distal end of the IVUS imaging catheter 108. During the post-PCI procedure, the IVUS imaging catheter 108 can be pulled back from a distal point 114 in the cardiac artery 102 to a proximal point 116 in the cardiac artery 102 and intravascular image frames are captured while the IVUS imaging catheter 108 is pulled back.

Where the PCI procedure involves placing the stents 106a, 106b, and/or 106c into the cardiac artery 102, a post-PCI procedure could involve imaging the cardiac artery 102 from the distal point 114 to the proximal point 116 to capture images of the stents 106a, 106b, and/or 106c. Physicians often use post-PCI procedures to assess how well the stents 106a, 106b, and/or 106c are placed and/or how well the stenosis of the cardiac artery 102 is corrected relative to pre-PCI images. To assist physicians in assessing the placement of the stents 106a, 106b, and/or 106c in cardiac artery 102, the present disclosure provides to group stent(s) detected from the IVUS image frames captured while the IVUS imaging catheter 108 is pulled back from distal point 114 to proximal point 116. This is explained in greater detail below. However, in general stents can grouped into stent segments based on the proximity of the stents to each other. For example, stent 106a has associated stent distal edge 118a and stent proximal edge 120a, stent 106b has associated stent distal edge 118b and stent proximal edge 120b, and stent 106c has associated stent distal edge 118c and stent proximal edge 120c. The detected stents (e.g., the stents 106a, 106b, and/or 106c) can be grouped into stent segments based on the distance between adjacent stent edges. For example, stent 106a could be grouped into a first stent segment (e.g., see FIG. 5) based on the distance between stent distal edge 118a and stent proximal edge 120b while the stents 106b and 106c can be grouped into a second stent segment (e.g., see FIG. 5) based on the distance between stent distal edge 118b and stent proximal edge 120c. With some embodiments, the distance between adjacent stent edges can be compared to a threshold distance and stents with adjacent edges less than or equal to the threshold distance can be grouped into the same stent segment.

The stent segments can be displayed on a GUI with each stent in each stent segment visually represented and a user can select a stent segment to interrogate via a stent assessment process and a physician can use this information presented via the GUI to assess the quality and/or effectiveness of the placement of stents 106a, 106b, and/or 106c in the cardiac artery 102.

The present disclosure can be implemented for any intravascular imaging modality. However, the balance of the disclosure uses IVUS imaging (e.g., captured via IVUS imaging catheter 108, or the like) as an exemplary modality. This is done for ease of discussion only. To aid this discussion, FIG. 1B illustrates an IVUS imaging system 122. The IVUS imaging system 122 is depicted including IVUS imaging catheter 108, which is couplable to a control system 124. The control system 124 may include, for example, an image acquisition circuitry 126, a pulse generator 128, and a motor drive unit (MDU) 130. In at least some embodiments, the pulse generator 128 forms electric pulses that may be input to one or more transducers (e.g., ultrasound transducer 112, or the like) disposed on IVUS imaging catheter 108.

With some embodiments, ultrasound transducer 112 can be part of an imaging core and coupled to the proximal end of IVUS imaging catheter 108 via a drive cable or drive shaft. Mechanical energy from the motor drive unit 130 can be used to rotate the imaging core (and thus the ultrasound transducer 112).

The electrical pulses generated by pulse generator 128 can be delivered to the ultrasound transducer 112 while the ultrasound transducer 112 is rotated by the motor drive unit 130. The electrical signals are transformed by the ultrasound transducer 112 into acoustic pulses that are transmitted through the tissue of cardiac vasculature structure 100. The tissue of cardiac vasculature structure 100 reflects the acoustic pulses, which are absorbed by the ultrasound transducer 112 and transformed into electric pulses. The transformed electric pulses are delivered to the image acquisition circuitry 126 and converted into IVUS images displayable on a monitor.

For example, image acquisition circuitry 126 can be configured to map scan line samples (e.g., radial scan line samples, or the like) to a two-dimensional Cartesian grid, which can be used as the basis for a series of IVUS images that can be displayed for a user. In at least some embodiments, the image acquisition circuitry 126 may also be used to control the functioning of one or more of the other components of the control system 124. For example, the image acquisition circuitry 126 may be used to control at least one of the frequency or duration of the electrical pulses transmitted from the pulse generator 128, the rotation rate of the imaging core by the motor drive unit 130, or the like. Additionally, where IVUS imaging system 122 is configured for automatic pullback, the motor drive unit 130 can control the velocity and/or length of the pullback region (e.g., distal point 114 to proximal point 116, or the like).

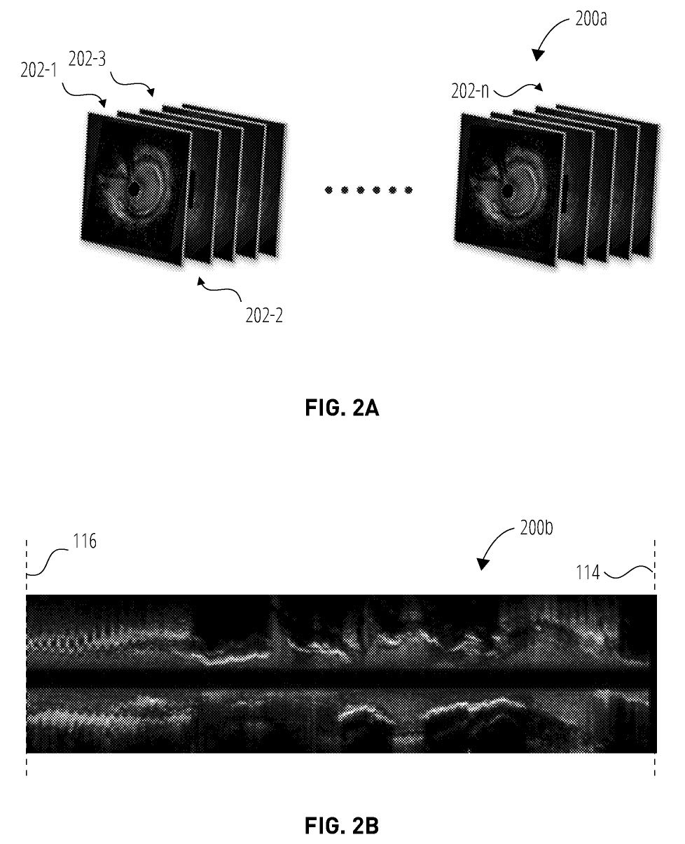

FIG. 2A and FIG. 2B illustrate a series of IVUS image frames 200a and a longitudinal view 200b of the series of IVUS image frames 200a. As described above, several IVUS image frames can be captured while IVUS imaging catheter 108 is moved through cardiac artery 102. For example, FIG. 2A depicts the series of IVUS image frames 200a including IVUS image frames 202-1, 202-2, 202-3 to 202-n, where n is a positive integer, in this case, greater than ten (10). In practice, n can be any positive integer greater than or equal to two (2) but will often be greater than one hundred.

The series of IVUS image frames 200a can be stacked or grouped and depicted longitudinally to represent a longitudinal slice of the cardiac artery 102 from distal point 114 to proximal point 116. For example, FIG. 2B illustrates longitudinal view 200b which shows a longitudinal slice of cardiac artery 102 from distal point 114 to proximal point 116 formed from the series of IVUS image frames 200a.

As noted above, a stent or stents (e.g., stents 106a, 106b, and/or 106c) may be represented in the series of IVUS image frames 200a (e.g., where they are captured as part of a post-PCI procedure, or the like). The disclosure provides to detect stents from the series of IVUS image frames 200a and to group the detected stents into stent segments based on the proximity of adjacent stent edges to each other.

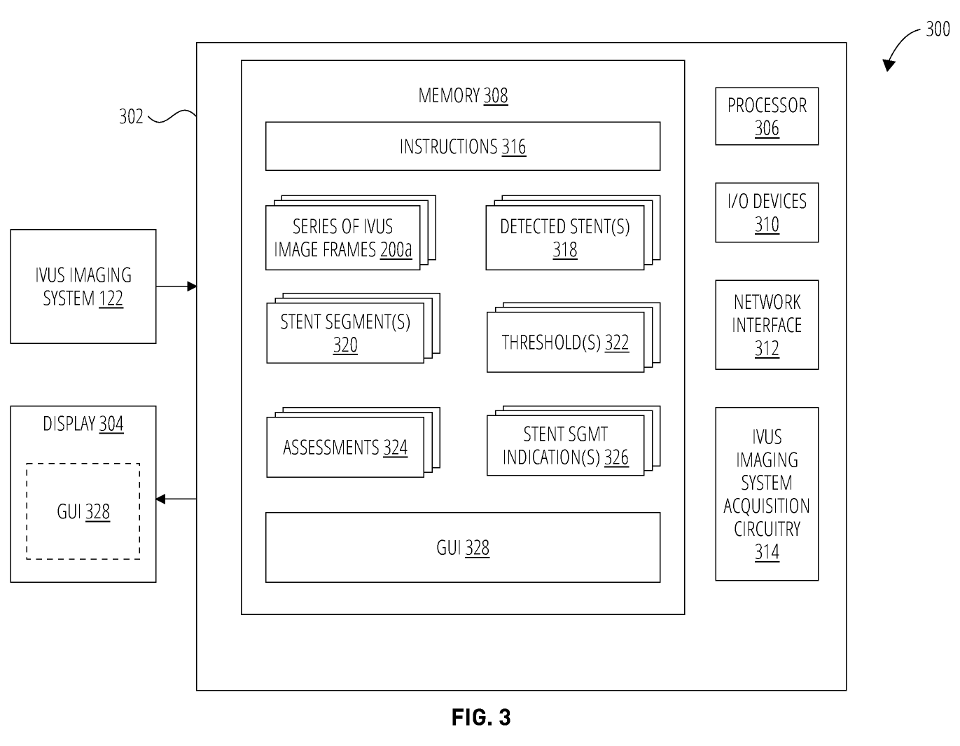

FIG. 3 illustrates an IVUS navigation system 300, which can be implemented to detect stents and group the detected stents into stent segments as part of a post-PCI procedure to image a cardiac artery having a stent or stents within the imaged region. In general, IVUS navigation system 300 is a system for processing, annotating, and/or presenting IVUS images. IVUS navigation system 300 can be implemented in a commercial IVUS guidance or navigation system, such as, for example, the AVVIGO^{TM} Guidance System available from Boston Scientific®. The present disclosure provides advantages over prior or conventional IVUS navigation systems in that the grouping of detected stents into stent segments allows a user (e.g., physician, or the like) to select relevant stent segments for stent assessment and make clinical decisions to improve patient outcomes related to the placement of the stent based on the stent assessments.

IVUS navigation system 300 includes a computing device 302 and display 304. Optionally, IVUS navigation system 300 includes an IVUS imaging system, such as IVUS imaging system 122. Where IVUS navigation system 300 includes IVUS imaging system 122, IVUS navigation system 300 could be implemented as part of control system 124 or alternatively, control system 124 could be implemented as part of computing device 302 of IVUS navigation system 300. IVUS navigation system 300 will be described with reference to cardiac vasculature structure 100 and IVUS imaging system 122 of FIG. 1A and FIG. 1B as well as series of IVUS image frames 200a and longitudinal view 200b of FIG. 2A and FIG. 2B for clarity and ease of discussion. However, it is noted that IVUS navigation system 300 could be implemented for use with another IVUS imaging system or even another intravascular imaging system utilizing a different imaging modality than IVUS imaging system 122.

Computing device 302 can be any of a variety of computing devices. In some embodiments, as noted above, computing device 302 can be incorporated into and/or implemented by a console to be coupled to an intravascular imaging device (e.g., IVUS imaging system 122, IVUS imaging catheter 108, or the like). With some embodiments, computing device 302 can be a workstation or server communicatively coupled to IVUS imaging system 122. With still other embodiments, computing device 302 can be provided by a cloud based computing device, such as, by a computing as a service system accessibly over a network (e.g., the Internet, an intranet, a wide area network, or the like). Computing device 302 can include processor 306, memory 308, input and/or output (I/O) devices 310, network interface 312, and IVUS imaging system acquisition circuitry 314.

Display 304 may include any of a variety of devices arranged to display graphical information, such as, a light emitting diode (LED) display, or the like. It is to be appreciated that although display 304 is depicted separate from computing device 302, display 304 could be implemented as part of computing device 302 or be distinct from computing device 302.

The processor 306 may include circuity or processor logic, such as, for example, any of a variety of commercial processors. In some examples, processor 306 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 306 may include graphics processing portions and may include dedicated memory, multiple-threaded processing and/or some other parallel processing capability. In some examples, the processor 306 may be an application specific integrated circuit (ASIC) or a field programmable integrated circuit (FPGA).

The memory 308 may include logic, a portion of which includes arrays of integrated circuits, forming non-volatile memory to persistently store data or a combination of non-volatile memory and volatile memory. It is to be appreciated, that the memory 308 may be based on any of a variety of technologies. In particular, the arrays of integrated circuits included in memory 308 may be arranged to form one or more types of memory, such as, for example, dynamic random access memory (DRAM), NAND memory, NOR memory, or the like.

I/O devices 310 can be any of a variety of devices to receive input and/or provide output. For example, I/O devices 310 can include, a keyboard, a mouse, a joystick, a foot pedal, a display, a touch enabled display, a haptic feedback device, an LED, or the like.

Network interface 312 can include logic and/or features to support a communication interface. For example, network interface 312 may include one or more interfaces that operate according to various communication protocols or standards to communicate over direct or network communication links. Direct communications may occur via use of communication protocols or standards described in one or more industry standards (including progenies and variants). For example, network interface 312 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 312 can include logic and/or features to enable communication over a variety of wired or wireless network standards. For example, network interface 312 may be arranged to support wired communication protocols or standards, such as, Ethernet, or the like. As another example, network interface 312 may be arranged to support wireless communication protocols or standards, such as, for example, Wi-Fi, Bluetooth, 5G, or the like.

The IVUS imaging system acquisition circuitry 314 may include circuity including custom manufactured or specially programmed circuitry configured to receive or receive and send signals with IVUS imaging system 122, including indications of intravascular images, intravascular image frames, or a series of intravascular image frames. For example, IVUS imaging system acquisition circuitry 314 can include image acquisition circuitry 126 and/or pulse generator 128.

Memory 308 can include instructions 316, series of IVUS image frames 200a, detected stent(s) 318, stent segment(s) 320, threshold(s) 322, assessments 324, stent segment graphical indication(s) 326, and graphical user interface (GUI) 328.

During operation, processor 306 can execute instructions 316 to cause computing device 302 to receive (e.g., from IVUS imaging system 122, or the like) a recording of an “IVUS run” and store the recording as the series of IVUS image frames 200a in memory 308. For example, processor 306 can execute instructions 316 to receive information elements from IVUS imaging system 122 comprising indications of IVUS image frames 202-1, 202-2, 202-3 to 202-n, captured by IVUS imaging catheter 108 while IVUS imaging catheter 108 is pulled through cardiac artery 102 from distal point 114 to proximal point 116 through the stents 106a, 106b, and/or 106c. It is to be appreciated that the series of IVUS image frames 200a can be stored in a variety of image formats or even non-image formats or data structures.

The present disclosure provides to process the series of IVUS image frames 200a to group stent(s) detected from the series of IVUS image frames 200a into stent segments and display visual indications of the stent segments via a GUI. In some examples, processor 306 can execute instructions 316 to receive indications of stent(s) detected from series of IVUS image frames 200a and store the indications as detected stent(s) 318. With some examples, processor 306 can execute instructions 316 to detect the stent(s) represented in the series of IVUS image frames 200a and store indications of the detected stent(s) as detected stent(s) 318. For example, processor 306 can execute instructions 316 to identify frames of series of IVUS image frames 200a (e.g., IVUS image frames 202-2, 202-3, etc.) where the stents 106a, 106b, and/or 106c are represented and store indications of the stents and/or the frames of the series of IVUS image frames 200a associated with the detected stents as detected stent(s) 318.

Complete details of stent detection techniques, such as techniques to identify frames of series of IVUS image frames 200a in which a stent is represented is beyond the scope of this disclosure. However, with some examples, processor 306 can execute instructions 316 to identify the detected stent(s) 318 from the series of IVUS image frames 200a using machine learning (ML) models trained to identify frames of a series of frames in which a stent is represented. As another example, processor 306 can execute instructions 316 to identify the detected stent(s) 318 from the series of IVUS image frames 200a using image processing algorithms to identify stent features in frames of a series of frames. With yet another example, processor 306 can execute instructions 316 to identify the detected stent(s) 318 from the series of IVUS image frames 200a using a combination of image processing techniques and ML models. For example, processor 306 can execute instructions 316 to apply a cross-sectional segmentation to the frames of the series of IVUS image frames 200a and then infer frames representing a stent from the frame segmentations using an ML model. It is noted that processor 306 can execute instructions 316 to identify edges of the stent or stents represented in the series of IVUS image frames 200a. For example, processor 306 can execute instructions 316 to identify the frames (e.g., IVUS image frames 202-2, 202-3, etc.) containing the edges of the stents 106a, 106b, and/or 106c (e.g., the stent distal edges 118a, 118b, and/or 118c and the stent proximal edges 120a, 120b, and/or 120c).

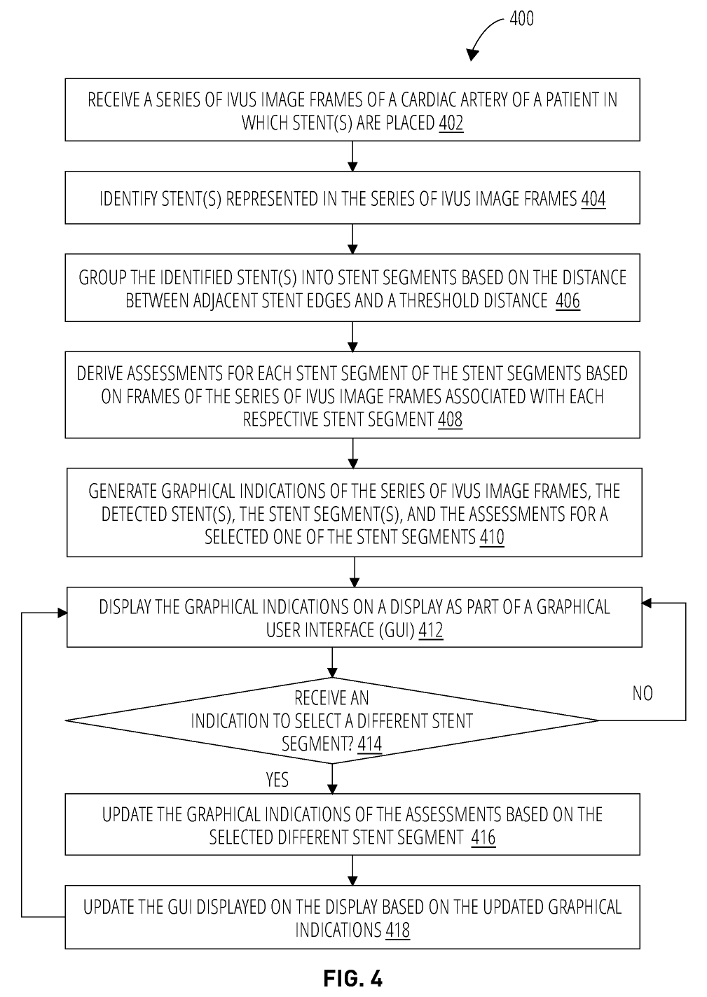

Processor 306 can execute instructions 316 to group the detected stent(s) 318 into stent segments and store indications of the stent segments as stent segment(s) 320. As used herein, the term stent segment refers to a collection of at least one detected stent. In general, processor 306 can execute instructions 316 to group the detected stent(s) 318 into stent segments based on the threshold(s) 322 and the distance between adjacent edges of each stent. This is described in greater detail below, for example, with respect to logic flow 400 and FIG. 4.

Further, processor 306 can execute instructions 316 to derive the assessments 324 for each of the stent segment(s) 320. In general, for each stent segment of the stent segment(s) 320, the assessments 324 can include vessel and/or lumen borders, raw vessel and/or lumen areas, smoothed vessel and/or lumen areas, a plaque burden, a stent expansion ratio, or the like. Complete detail of derivation of stent assessments is beyond the scope of this disclosure. However, with some examples, processor 306 can execute instructions 316 to determine the assessments (e.g., boundaries, area, plaque burden, expansion ratio, etc.) of the vessel and/or lumen depicted in each frame of the series of IVUS image frames 200a associated with each stent segment of the stent segment(s) 320. In some embodiments, this can include identifying key frames for each stent segment of the stent segment(s) 320 and then deriving the assessments 324 based on the identified key frames. With some embodiments, processor 306 can execute instructions 316 to determine the assessments 324 using image processing techniques, ML models, or a combination of image processing techniques and ML models.

Examples of processing IVUS images to detect stents and/or derive assessments are described in more detail in United States Patent Application Publication No. 2023/0157672, titled “Intravascular Ultrasound Imaging and Calcium Detection Methods” and filed on March 1, 2022; United States Patent Application Publication No. 2023/0112017, titled “Medical Device Systems for Automatic Lesion Assessment” and filed on October 5, 2022; United States Patent Application Publication No. 2023/0380806, titled “Systems and Methods for Intravascular Visualization” and filed on May 26, 2023; United States Patent Application Publication No. 2024/0081781, titled “Graphical User Interface for Intravascular Ultrasound Stent Display” and filed on September 13, 2023; which applications are each incorporated herein by reference in their entirety.

Processor 306 can execute instructions 316 to generate stent segment graphical indication(s) 326 for stent segment(s) 320 and/or generate GUI 328 from stent segment graphical indication(s) 326. In general, the stent segment graphical indication(s) 326 and/or GUI 328 can comprise visual indications of the series of IVUS image frames 200a, the detected stent(s) 318, the stent segment(s) 320, and the assessments 324 for a stent segment of the stent segment(s) 320. The stent segment of the stent segment(s) 320 with assessments 324 as visually depicted in GUI 328 can be selected by a user via the GUI 328 or can be selected based on a default selection. Examples of this are described in greater detail below.

FIG. 4 illustrates a logic flow 400 to group detected stent(s) into stent segments and display visual indications of the detected stent(s) and the stent segments in a GUI. The stent(s) can be detected from a series of IVUS image frames captured during a post-PCI procedure. The logic flow 400 can be implemented by IVUS navigation system 300 and will be described with reference to IVUS navigation system 300 for clarity of presentation. However, it is noted that logic flow 400 could also be implemented by an IVUS navigation system different than IVUS navigation system 300. Further, logic flow 400 is described with reference to cardiac vasculature structure 100 and IVUS imaging system 122 of FIG. 1A and FIG. 1B and the series of IVUS image frames 200a and longitudinal view 200b of FIG. 2A and FIG. 2B for clarity of presentation.

Logic flow 400 can begin at block 402. At block 402 “receive a series of intravascular ultrasound (IVUS) image frames of a vessel of a patient in which stent(s) are placed” a series of IVUS image frames captured during a post-PCI procedure via an IVUS catheter percutaneously inserted in a vessel of a patent can be received. For example, information elements comprising indications of series of IVUS image frames 200a can be received from IVUS imaging system 122 where IVUS imaging catheter 108 is (or was) percutaneously inserted into cardiac artery 102 of cardiac vasculature structure 100. As described above, the series of IVUS image frames 200a includes several frames (e.g., IVUS image frames 202-1, 202-2, and 202-3 to 202-n) captured while the IVUS imaging catheter 108 is pulled back from the distal point 114 to proximal point 116 through the stents 106a, 106b, and/or 106c. Processor 306 can execute instructions 316 to receive information elements comprising indications of series of IVUS image frames 200a from IVUS imaging system 122, or directly from IVUS imaging catheter 108 as may be the case.

Continuing to block 404 “identify stent(s) represented in the series of IVUS image frames” stent(s) represented in the series of IVUS image frames are identified. For example, processor 306 can execute instructions 316 to receive indications of stents represented in the series of IVUS image frames 200a detected based on a stent detection process and store the indications as detected stent(s) 318. As another example, processor 306 can execute instructions 316 to identify detected stent(s) 318 from the series of IVUS image frames 200a based on an automatic stent detection process (e.g., using ML, image processing, or a combination of ML and image processing).

Continuing to block 406 “group the identified stent(s) into stent segments based on the distance between adjacent stent edges and a threshold distance” the identified stent(s) can be grouped into stent segments based on the distance between adjacent stent edges and a threshold distance. For example, processor 306 can execute instructions 316 to group detected stent(s) 318 into stent segment(s) 320 based on threshold(s) 322. Processor 306 can execute instructions 316 to determine whether adjacent stent edges of the detected stent(s) 318 are less than or equal to a threshold distance of threshold(s) 322 from each other and group respective stents into the same or different stent segment(s) 320 based on the determination. A more detailed example of this is provided with respect to the logic flow 500 and FIG. 5 discussed below.

With some examples, processor 306 can execute instructions 316 to determine, for each pair of adjacent proximal and distal stent edges (e.g., stent proximal edge 120c and stent distal edge 118b or stent proximal edge 120b and stent distal edge 118a, or the like), whether the distance between the pair of adjacent stent edges is less than or equal to the threshold value (e.g., 5.0 mm, or the like) and group the detected stents into the same stent segment (e.g., where the distance is less than or equal to the threshold) or different stent segments (e.g., where the distance is not less than or equal to the threshold).

Continuing to block 408 “derive assessments for each stent segment of the stent segments based on frames of the series of IVUS image frames associated with each respective stent segment” assessments for each stent segments can be derived based on the frame of the series of IVUS image frames associated with the respective stent segment. For example, processor 306 can execute instructions 316 to derive assessments 324 for frames of series of IVUS image frames 200a associated with the stent segments of stent segment(s) 320 based on a stent assessment process. In some examples, the stent assessment process can include identifying key frames associated with the stent segment, deriving vessel and/or lumen assessments (e.g., borders, area, plaque burden, etc.), and deriving stent specific assessments (e.g., stent expansion ratio, etc.) for each stent segment.

Continuing to block 410 “generate graphical indications of the series of IVUS image frames, the detected stent(s), the stent segment(s), and the assessments for a selected one of the stent segments” graphical indications of the series of IVUS image frames, the detected stent(s), the stent segment(s), and the assessments associated with a selected one of the stent segments can be generated. For example, processor 306 can execute instructions 316 to generate stent segment graphical indication(s) 326 comprising visual representations of series of IVUS image frames 200a, detected stent(s) 318, stent segment(s) 320, and assessments 324 associated with a selected one of stent segment(s) 320. In some examples, the selected one of stent segment(s) 320 is a default selection. For example, in the absence of an indication to select a particular stent segment of stent segment(s) 320 (e.g., via the GUI 328, or the like), processor 306 can execute instructions 316 to select the distal most complete stent (or stent segment comprising the distal most complete stent) of stent segment(s) 320 as the selected stent segment. With some examples, where there are no complete stent(s), processor 306 can execute instructions 316 to select the distal most stent segment of stent segment(s) 320 as the selected stent segment.

Continuing to block 412 “display the graphical indications on a display as part of a graphical user interface (GUI)” the graphical indications generated at block 410 can be displayed on a display as part of a GUI. For example, processor 306 can execute instructions 316 to generate GUI 328 with visual representations of the stent segment graphical indication(s) 326 and display the GUI 328 on display 304. With some examples, the GUI 328 can visually emphasize (e.g., highlight, shade, set apart, color differently, or the like) the stent segment of stent segment(s) 320 selected as the “active stent segment.”

Continuing to decision block 414 “receive an indication to select a different stent segment?” a determination is made whether an indication to select a different stent segment is received. For example, processor 306 can execute instructions 316 to determine whether an indication to change the selected stent segment of stent segment(s) 320 (e.g., the active stent segment) is received (e.g., via GUI 328, or the like).

From decision block 414, logic flow 400 can continue to block 416 or return to block 412. For example, logic flow 400 can continue from decision block 414 to block 416 where a determination is made that an indication to select a different stent segment is received while logic flow 400 can return to block 412 from decision block 414 where a determination is made at decision block 414 that an indication to select a different stent segment is not received.

At block 416 “update the graphical indications of the assessments based on the selected different stent segment” graphical indications of the assessments can be updated based on assessments 324 associated with the selected different stent segment of stent segment(s) 320. For example, processor 306 can execute instructions 316 to update (or regenerate as may be the case) stent segment graphical indication(s) 326 comprising visual representations of the assessments 324 associated with the stent segment of stent segment(s) 320 selected at decision block 414.

Continuing to block 418 “update the GUI displayed on the display based on the updated graphical indications” the GUI displayed on the display can be updated to visually depict the updated graphical indications showing assessments for the stent segment selected at decision block 414. Further, the GUI 328 can be updated to visually emphasize (e.g., highlight, shade, set apart, color differently, or the like) the stent segment of stent segment(s) 320 selected as the “active stent segment” at decision block 414. Logic flow 400 can return to block 412 from block 418. As such logic flow 400 can provide that GUI 328 can be continually updated as a user navigates through the stents detected from series of IVUS image frames 200a and the stent segment(s) 320.

FIG. 5 illustrates a logic flow 500, which can be implemented to group the detected stent(s) 318 into stent segment(s) 320. In some examples, logic flow 400 of FIG. 4 can implement logic flow 500 at block 406. Logic flow 500 can begin at decision block 502. At decision block 502 “multiple stents detected?” a determination is made of whether multiple stents are detected from the series of IVUS image frames. For example, processor 306 can execute instructions 316 to determine whether multiple stents (e.g., stents 106a, 106b, and/or 106c, or the like) are detected from series of IVUS image frames 200a as defined by detected stent(s) 318.

From decision block 502, logic flow 500 can continue to block 504 or block 506. For example, logic flow 500 can continue from decision block 502 to block 504 where a determination is made at decision block 502 that multiple stents are not detected from the series of IVUS image frames while logic flow 500 can continue from decision block 502 to block 506 where a determination is made at decision block 502 that multiple stents are detected from the series of IVUS image frames.

At block 504 “group the stent into a stent segment” the stent (e.g., stent 106a, or the like) detected from series of IVUS image frames (e.g., series of IVUS image frames 200a, or the like) can be grouped into a stent segment. For example, processor 306 can execute instructions 316 to group the stent of detected stent(s) 318 as a stent segment and store the stent segment as stent segment(s) 320.

At block 506 “designate the most distal stent as a first stent and the next most distal stent as a second stent” the most distal stent in the run can be designated as a first stent and the next most distal stent in the run designated as a second stent. For example, processor 306 can execute instructions 316 to designate the most distal stent of detected stent(s) 318 (e.g., stent 106c) as the first stent and designate the next most distal stent of the detected stent(s) 318 (e.g., the stent 106b) as the second stent.

Continuing to decision block 508 “proximal stent edge of the first stent less than or equal to a first threshold distance from the distal stent edge of the second stent?” a determination is made of whether the proximal stent edge of the first stent is less than or equal to a first threshold distance from the distal edge of the second stent. For example, processor 306 can execute instructions 316 to determine whether the proximal stent edge of the first stent (e.g., stent proximal edge 120c of stent 106c) is less than or equal to a distance defined in threshold(s) 322 from the distal stent edge of the second stent (e.g., stent distal edge 118b of stent 106b). With some examples, the threshold distance is 5 millimeters (mm). In some examples, the threshold distance is 3.5 mm, 4.0 mm, 4.5 mm, 5.5 mm, 6.0 mm, or 6.5 mm. In some examples, the threshold distance is between 3.5 mm and 6.5 mm.

From decision block 508, logic flow 500 can continue to block 510 or block 512. For example, logic flow 500 can continue from decision block 508 to block 510 where a determination is made at decision block 508 that the proximal stent edge of the first stent is less than or equal to the first threshold distance from the distal edge of the second stent while logic flow 500 can continue from decision block 508 to block 512 where a determination is made at decision block 508 that the proximal stent edge of the first stent is not less than or equal to the first threshold distance from the distal edge of the second stent.

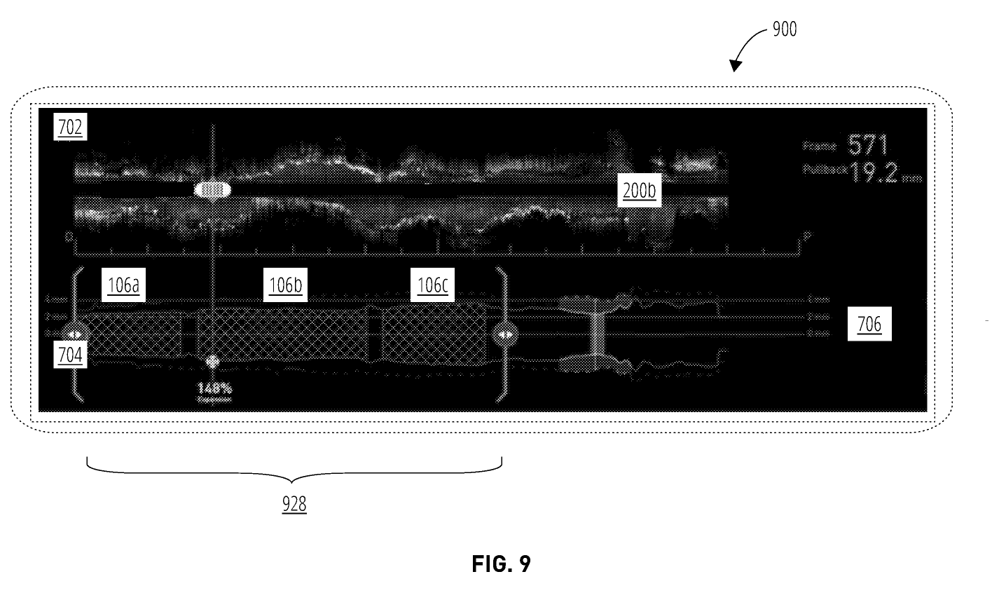

At block 510 “group the first stent and the second stent into the same stent segment” the first and second stents can be grouped into the same stent segment. For example, processor 306 can execute instructions 316 to group the designated first and second stents (e.g., stent 106c and stent 106b, or the like) into the same stent segment of the stent segment(s) 320. For example, stent segment 928 of GUI 900 depicted in FIG. 9 shows stents 106a, 106b, and 106c in the same stent segment 928.

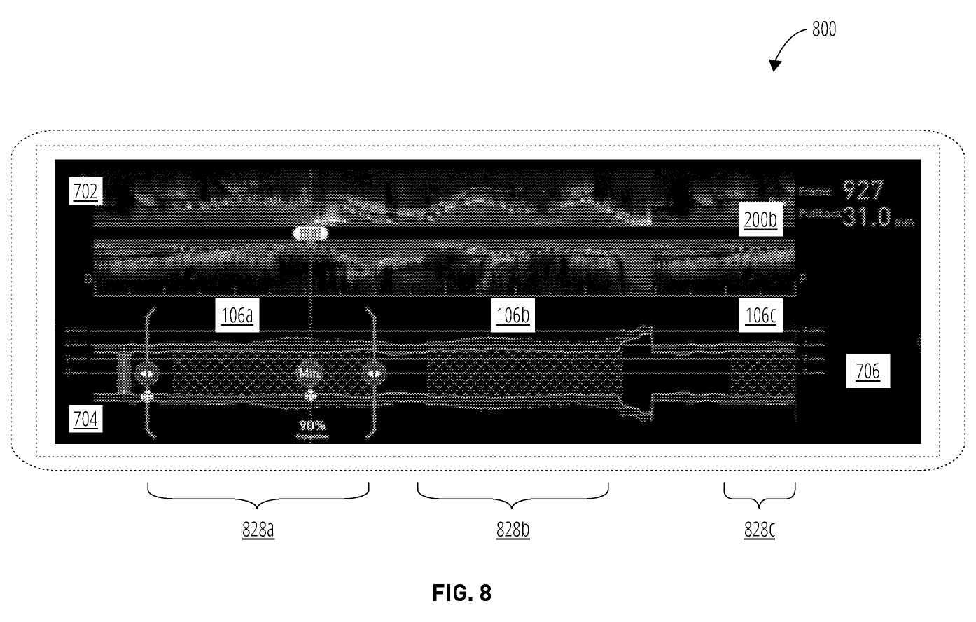

At block 512 “group the first stent and the second stent into different stent segments” the first and second stents can be grouped into different stent segments. For example, processor 306 can execute instructions 316 to group the designated first and second stents (e.g., stent 106c and stent 106b, or the like) into different stent segments of the stent segment(s) 320. For example, stent segments 828b and 828c of GUI 800 depicted in FIG. 8 shows stents 106b and 106c in different stent segments.

Continuing from block 510 and block 512 to decision block 514 “is there a detected stent proximal to the second stent?” a determination is made whether there is a detected stent that is proximal to the second stent. For example, processor 306 can execute instructions 316 to determine whether the detected stent(s) 318 includes a stent proximal to the second stent. Using the example above where stent 106b is designated as the second stent, processor 306 can execute instructions 316 to determine that stent 106a is proximal to stent 106b.

From decision block 514, logic flow 500 can continue to block 516 or can end. For example, logic flow 500 can continue from decision block 514 to block 516 where a determination is made at decision block 514 that there is a detected stent that is proximal to the second stent while logic flow 500 can end after decision block 514 where a determination is made at decision block 514 that there is not a detected stent that is proximal to the second stent.

At block 516 “designate the second stent as the first stent and the stent proximal to the second stent as the second stent” the second stent can be designated as the first stent and the stent proximal to the second stent designated as the second stent. For example, processor 306 can execute instructions 316 to designate the second stent as the first stent and the stent proximal to the second stent as the second stent. Using the example above where stent 106b is designated as the second stent, processor 306 can execute instructions 316 to designate stent 106b as the first stent and designate stent 106a as the second stent. Logic flow 500 can return to decision block 508 from block 516. As such, logic flow 500 provides that all detected stent(s) 318 can be iterated through to group them into stent segment(s) 320 based on the distance between adjacent ones of the stent edges.

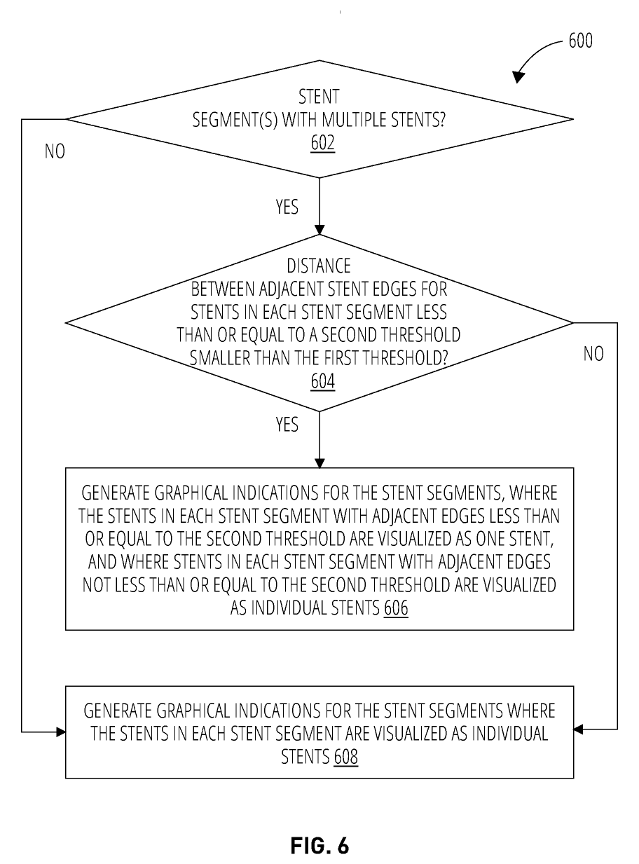

FIG. 6 illustrates a logic flow 600, which can be implemented to generate graphical indications of detected stent(s) 318 based on stent segment(s) 320. In some examples, logic flow 400 of FIG. 4 can implement logic flow 600 at block 410. Logic flow 600 can begin at decision block 602. At decision block 602 “stent segment(s) with multiple stents?” a determination is made of whether any stent segments include multiple stents. For example, processor 306 can execute instructions 316 to determine whether any stent segment of stent segment(s) 320 include multiple ones of detected stent(s) 318. As outlined above, where adjacent stent edges are less than or equal to a first threshold value (e.g., 5 mm, or the like) the stents will be grouped into the same stent segment. As such, some stent segments of stent segment(s) 320 will include multiple stents of detected stent(s) 318.

From decision block 602, logic flow 600 can continue to decision block 604 or block 608. For example, logic flow 600 can continue from decision block 602 to decision block 604 where a determination is made at decision block 602 that at least one stent segment includes multiple stents while logic flow 600 can continue from decision block 602 to block 608 where a determination is made at decision block 602 that none of stent segments includes multiple stents.

At decision block 604 “distance between adjacent stent edges for stents in each stent segment less than or equal to a second threshold smaller than the first threshold?” a determination is made of whether the distance between adjacent stent edge for stents in each stent segment is less than or equal to a second threshold distance that is smaller than the first threshold distance used to group the stents into stent segments (e.g., as discussed with respect to logic flow 500 of FIG. 5). For example, processor 306 can execute instructions 316 to determine whether the distance between adjacent stent edges for stents in each stent segment of stent segment(s) 320 is less than or equal to a second threshold distance defined in threshold(s) 322 where the second distance is less than the first distance. With some examples, the second threshold distance is 2 mm. In some examples, the second threshold distance is 1 mm, 1.5 mm, 2.5 mm, or 3 mm. In some examples, the second threshold distance is between 1 mm and 3 mm.

From decision block 604, logic flow 600 can continue to block 606 or block 608. For example, logic flow 600 can continue from decision block 604 to block 606 where a determination is made at decision block 604 that the distance between at least one pair of adjacent stent edge for stents in at least one stent segment is less than or equal to the second threshold distance while logic flow 600 can continue from decision block 604 to block 608 where a determination is made at decision block 604 that the distance between all pairs of adjacent stent edge for stents in each stent segment is not less than or equal to the second threshold distance.

At block 606 “generate graphical indications for the stent segments, where the stents in each stent segment with adjacent edges less than or equal to the second threshold are visualized as one stent, and where stents in each stent segment with adjacent edges not less than or equal to the second threshold are visualized as individual stents” graphical indications of the detected stent(s) and the stent segment(s) can be generated where stents in each stent segment with adjacent stent edges less than or equal to the second threshold distance are visualized as one stent while stents in each stent segment with adjacent stent edges not less than or equal to the second threshold distance are visualized as individual stents. For example, processor 306 can execute instructions 316 to generate stent segment graphical indication(s) 326 comprising visual representations of the stent segment(s) 320 including respective ones of the detected stent(s) 318, wherein stents of detected stent(s) 318 in each stent segment(s) 320 with adjacent stent edges less than or equal to the second threshold distance (e.g., 2 mm, or the like) from each other are visually depicted as one stent. In some examples, the gap between the stents is “filled in” with shading, hatching, or other visual depiction such that the stents appear as one in the GUI 328.

For example, where stents 106b and 106c are grouped into the same stent segment of stent segment(s) 320 and where stent proximal edge 120c and stent distal edge 118b are less than the second threshold distance from each other, processor 306 can execute instructions 316 to generate stent segment graphical indication(s) 326 wherein the stents 106b and 106c are visually depicted as one (e.g., the gap between stents 106b and 106c is filled with hatched fill to appear as a stent, or the like). As another example, where stents 106a, 106b, and 106c are grouped into the same stent segment of stent segment(s) 320 and where stent proximal edge 120c and stent distal edge 118b are less than the second threshold distance from each other and stent proximal edge 120b and stent distal edge 118a are not less than or equal to the second threshold distance from each other, processor 306 can execute instructions 316 to generate stent segment graphical indication(s) 326 wherein the stents 106b and 106c are visually depicted as one (e.g., the gap between stents 106b and 106c is filled with hatched fill to appear as a stent, or the like) and stents 106a and 106b are visualized individually.

At block 608 “generate graphical indications for the stent segments where the stents in each stent segment are visualized as individual stents” graphical indications of the detected stent(s) and the stent segment(s) can be generated where stents in each stent segment are visualized individually. For example, processor 306 can execute instructions 316 to generate stent segment graphical indication(s) 326 comprising visual representations of the stent segment(s) 320 including respective ones of the detected stent(s) 318, wherein each stent of detected stent(s) 318 in each stent segment(s) 320 is visually represented as an individual stent in the GUI 328.

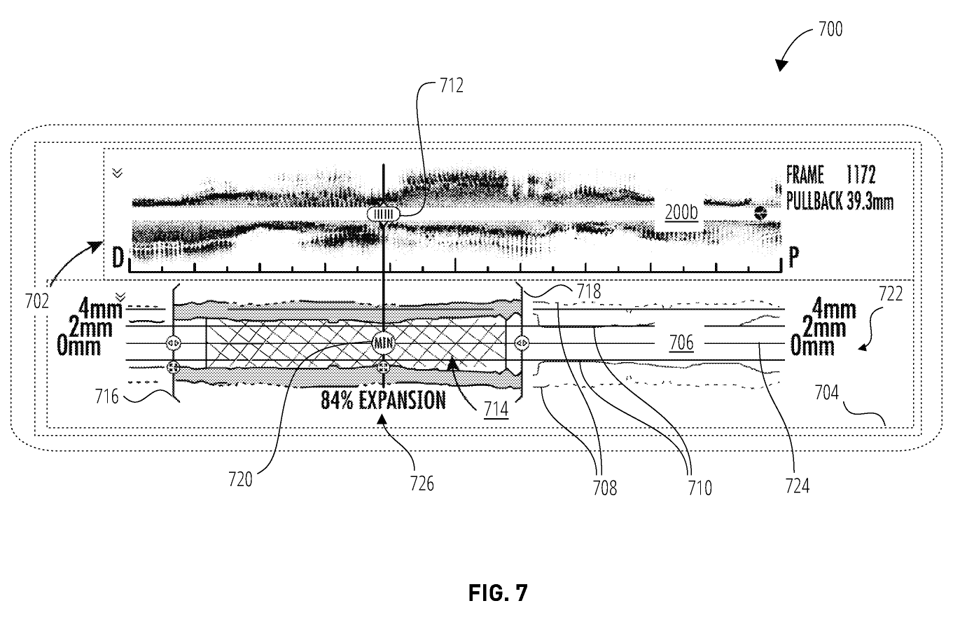

FIG. 7 illustrates a GUI 700, which can be generated according to some embodiments of the present disclosure. For example, GUI 700 can be generated by IVUS navigation system 300 as GUI 328 and displayed on display 304. With some embodiments, responsive to detection of detected stent(s) 318 from the series of IVUS image frames 200a, the processor 306 can execute instructions 316 to group the detected stent(s) 318 into stent segment(s) 320, derive assessments 324 for the stent segment(s) 320, and generate GUI 700. It is to be appreciated, that in some examples, a single stent (e.g., stent 106a, 106b, or 106c) can be detected from series of IVUS image frames 200a. In such an example, a single stent segment(s) 320 including the single detected stent can be determined.

GUI 700 can be generated where a single stent is detected from series of IVUS image frames 200a. GUI 700 can include a longitudinal vessel graphical indication 702 and a longitudinal vessel depiction graphical indication 704. The longitudinal vessel graphical indication 702 can include longitudinal view 200b while longitudinal vessel depiction graphical indication 704 can include a vessel profile 706 of longitudinal view 200b showing vessel borders 708 and lumen borders 710. Further, GUI 700 can include a slider 712, which can be manipulated (e.g., via I/O devices 310, or the like) to move or slide along the frames in series of IVUS image frames 200a depicted by longitudinal view 200b.

Longitudinal vessel depiction graphical indication 704 can further include a depiction of the single detected stent (e.g., the stent 106a, or the like) represented in longitudinal view 200b as well as indications of the assessments (e.g., key frames, or the like) identified as outlined herein. For example, FIG. 7 depicts GUI 700 with longitudinal vessel depiction graphical indication 704 showing stent 714 (e.g., representative of stent 106a in cardiac artery 102) as well as distal key frame marker 716, proximal key frame marker 718, and minimum key frame marker 720.

With some embodiments GUI 700 can include a scale 722 measured radially from a longitudinal axis 724 about which the vessel profile 706 is depicted. Processor 306 can execute instructions 316 to shade, color, or otherwise format the graphical visualization (e.g., line weight, solid line, dashed line, dotted line, area shading, area color, area pattern, etc.) to indicate plaque, confidence of border detection, a detected stent, or the like. For example, the area between vessel border 708 and lumen border 710 and between the distal key frame marker 716 and proximal key frame marker 718 can be shaded a different color than the background of GUI 700 to indicate a plaque burden of this region of the cardiac artery 102. Similarly, portions of the lines indicating the vessel border 708 and/or the lumen border 710 can be solid while other portions can be dashed indicating a confidence in the detection of the border for that respective frame of series of IVUS image frames 200a (or section of longitudinal view 200b). Similarly, vessel border 708 and lumen border 710 can be different colors to indicate which is the vessel border and which is the lumen border. With further examples, the stent 714 can be represented as a patterned area. such as, with hatch marks or the like.

Additionally, GUI 700 can include a graphical representation of assessments 324, such as, a stent expansion ratio. For example, GUI 700 includes expansion graphical indication 726 showing (e.g., as a percentage, ratio, or the like) a determined expansion of the detected stent (e.g., stent 106a, or the like) represented by stent 714. With some examples, the expansion ratio shown in expansion graphical indication 726 can be derived based on the minimum stent area (MSA) divided by the lumen area multiplied by 100 and visualized as a percentage as shown.

FIG. 8 illustrates a GUI 800, which can be generated according to some embodiments of the present disclosure. Like GUI 700, GUI 800 can be generated by IVUS navigation system 300 as GUI 328 and displayed on display 304. With some embodiments, responsive to detection of detected stent(s) 318 from the series of IVUS image frames 200a, the processor 306 can execute instructions 316 to group the detected stent(s) 318 into stent segment(s) 320, derive assessments 324 for the stent segment(s) 320, and generate GUI 800. As contemplated herein, multiple stents (e.g., stent 106a, 106b, and/or 106c) can be detected from the series of IVUS image frames 200a and grouped into stent segment(s) 320.

GUI 800 can be generated where multiple stents are detected from the series of IVUS image frames 200a and grouped into individual stent segment(s) 320. GUI 800 can include similar visual depictions or elements as GUI 700, such as the longitudinal vessel graphical indication 702 and the longitudinal vessel depiction graphical indication 704. Further, GUI 800 can include other similar visual depictions or elements as GUI 700, although not every graphical element of GUI 800 that is described in GUI 700 is called out for purposes of clarity.

Longitudinal vessel depiction graphical indication 704 of GUI 800 can include depictions of the detected stent(s) 318 and the stent segment(s) 320. For example, longitudinal vessel depiction graphical indication 704 of GUI 800 depicted in FIG. 8 includes visual depictions of the detected stent(s) 318 (e.g., the stents 106a, 106b, and 106c). As outlined above, the detected stent(s) 318 (e.g., the stents 106a, 106b, and 106c) can be grouped into stent segment(s) 320 based on the distance between adjacent stent edges. In some examples, all detected stent(s) 318 can be grouped into individual stent segment(s) 320 (e.g., where all adjacent stent edges are greater than the threshold distance from each other).

Longitudinal vessel depiction graphical indication 704 of GUI 800 depicted in FIG. 8 shows stent segments 828a, 828b, and 828c corresponding to stents 106a, 106b, and 106c, respectively. Further, longitudinal vessel depiction graphical indication 704 of GUI 800 emphasizes the stent segment 828a as the selected stent segment and assessments 324 associated with stent segment 828a are visually depicted in GUI 800.

As contemplated herein, a user can navigate through the stent segments 828a, 828b, and 828c depicted in longitudinal vessel depiction graphical indication 704 of GUI 800 by interacting with the GUI 800. For example, a user can use an I/O device 310 (e.g., mouse, touch screen, etc.) to click on one of the stent segments 828a, 828b, or 828c to select the particular stent segment.

FIG. 9 illustrates a GUI 900, which can be generated according to some embodiments of the present disclosure. Like GUIs 700 and 800, GUI 900 can be generated by IVUS navigation system 300 as GUI 328 and displayed on display 304. With some embodiments, responsive to detection of detected stent(s) 318 from the series of IVUS image frames 200a, the processor 306 can execute instructions 316 to group the detected stent(s) 318 into stent segment(s) 320, derive assessments 324 for the stent segment(s) 320, and generate GUI 900. As contemplated herein, multiple stents (e.g., stent 106a, 106b, and/or 106c) can be detected from the series of IVUS image frames 200a and grouped into stent segment(s) 320.

GUI 900 can be generated where multiple stents are detected from the series of IVUS image frames 200a and grouped into one or more stent segment(s) 320. GUI 900 can include similar visual depictions or elements as GUIs 700 and 800, such as the longitudinal vessel graphical indication 702 and the longitudinal vessel depiction graphical indication 704. Further, GUI 900 can include other similar visual depictions or elements as the GUIs 700 and 800, although not every graphical element of the GUI 900 that is described in the GUIs 700 and 800 is called out for purposes of clarity.

Longitudinal vessel depiction graphical indication 704 of GUI 900 can include depictions of the detected stent(s) 318 and the stent segment(s) 320. For example, longitudinal vessel depiction graphical indication 704 of GUI 900 depicted in FIG. 9 includes visual depictions of the detected stent(s) 318 (e.g., the stents 106a, 106b, and 106c). As outlined above, the detected stent(s) 318 (e.g., the stents 106a, 106b, and 106c) can be grouped into stent segment(s) 320 based on the distance between adjacent stent edges. In some examples, multiple ones of the detected stent(s) 318 can be grouped into the same stent segment of stent segment(s) 320 (e.g., where adjacent stent edges of the multiple ones of the detected stent(s) 318 are less than or equal to the threshold distance from each other).

Longitudinal vessel depiction graphical indication 704 of GUI 900 depicted in FIG. 9 shows stent segment 928 corresponding to (or including) stents 106a, 106b, and 106c. Further, longitudinal vessel depiction graphical indication 704 of GUI 900 emphasizes the stent segment 928 as the selected stent segment and assessments 324 associated with stent segment 928 are visually depicted in GUI 900.

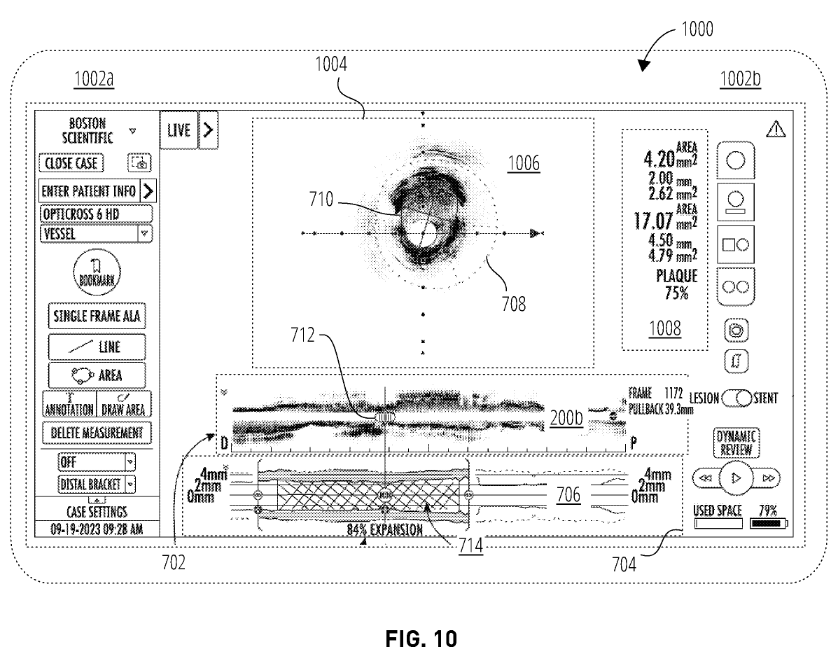

FIG. 10 illustrates a GUI 1000, which can be generated according to some embodiments of the present disclosure. For example, GUI 1000 can be generated by IVUS navigation system 300 as GUI 328 and displayed on display 304. With some embodiments, responsive to detection of a stent in series of IVUS image frames 200a, processor 306 can execute instructions 316 to generate GUI 1000. It is noted that GUI 1000 includes some graphical features of GUIs 700, 800, and/or 900. As such, GUI 1000 is described with reference to these GUIs.

GUI 1000 can includes menu 1002a and menu 1002b disposed on either sides of (or framing) graphical representations of cross-sectional frame graphical indication 1004, longitudinal vessel graphical indication 702, and longitudinal vessel depiction graphical indication 704 where longitudinal vessel graphical indication 702 shows longitudinal view 200b and longitudinal vessel depiction graphical indication 704 shows vessel profile 706 and stent 714 as described above with respect to FIG. 7 and GUI 700. It is noted however, that GUI 1000 could include a longitudinal vessel depiction graphical indication 704 like that depicted in GUIs 800 or 900, such as, for example, where multiple stents are detected from series of IVUS image frames 200a.

The cross-sectional frame graphical indication 1004 can include depictions of on-axis IVUS image frame view 1006 corresponding to the frame of series of IVUS image frames 200a in which the slider 712 is positioned. Further, cross-sectional frame graphical indication 1004 can include indications of vessel border 708 and/or lumen border 710 as may be derived based on the frame depicted in on-axis IVUS image frame view 1006.

In some examples, GUI 1000 can include assessment graphical indication 1008 showing graphical representations of assessments 324 (e.g., vessel and/or lumen area, plaque burden, etc.)

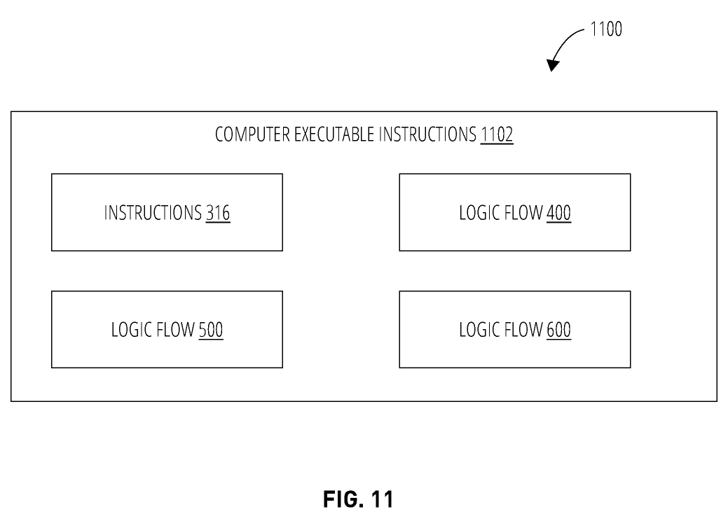

FIG. 11 illustrates computer-readable storage medium 1100. Computer-readable storage medium 1100 may comprise any non-transitory computer-readable storage medium or machine-readable storage medium, such as an optical, magnetic or semiconductor storage medium. In various embodiments, computer-readable storage medium 1100 may comprise an article of manufacture. In some embodiments, computer-readable storage medium 1100 may store computer executable instructions 1102 with which circuitry (e.g., image acquisition circuitry 126, processor 306, IVUS imaging system acquisition circuitry 314, and the like) can execute. For example, computer executable instructions 1102 can include instructions to implement operations described with respect to instructions 316, logic flow 400, logic flow 500, and/or logic flow 600. Examples of computer-readable storage medium 1100 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1102 may include any suitable type of code, such as source code, compiled code, interpreted code, executable code, static code, dynamic code, object-oriented code, visual code, and the like.

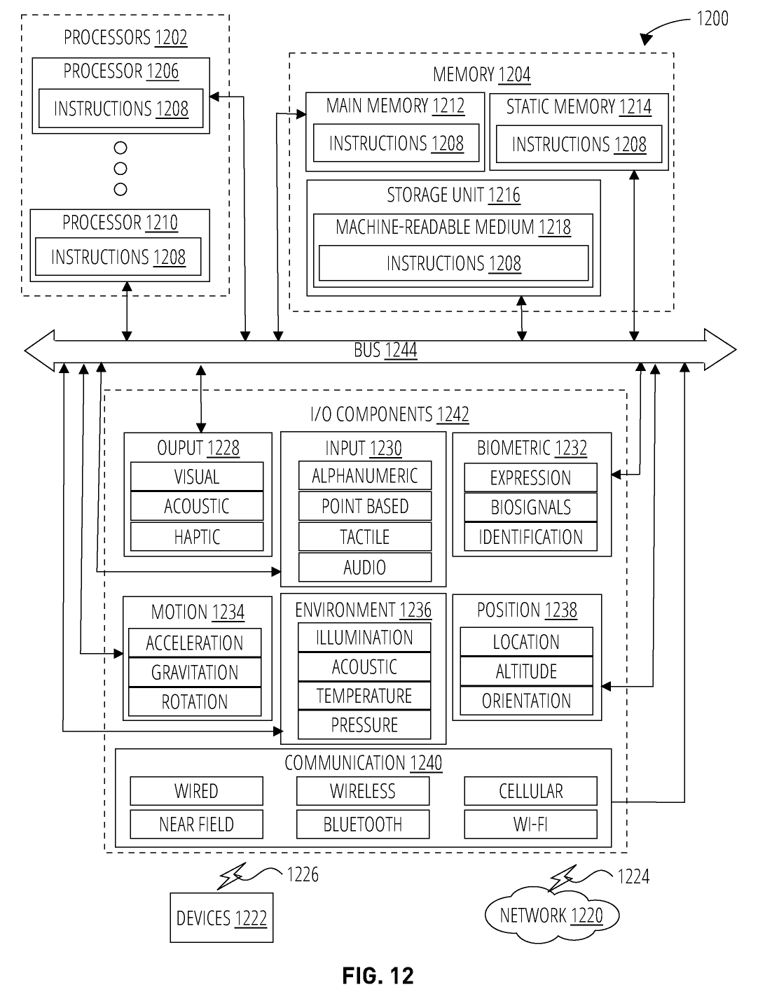

FIG. 12 illustrates a diagrammatic representation of a machine 1200 in the form of a computer system within which a set of instructions may be executed for causing the machine to perform any one or more of the methodologies discussed herein. More specifically, FIG. 12 shows a diagrammatic representation of the machine 1200 in the example form of a computer system, within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute logic flow 400 of FIG. 4, logic flow 500 of FIG. 5, and/or logic flow 600 of FIG. 6, or the like. More generally, the instructions 1208 may cause the machine 1200 to group detected stents into stent segments and generate a GUI wherein the stent segments can be navigated through during a post-PCI procedure. It is noted that the present disclosure provides specific and discrete implementations of grouping detected stents (e.g., detected stent(s) 318) into stent segments (e.g., stent segment(s) 320) which is a significant improvement over the prior art. In particular, the present disclosure provides an improvement to computing technology in that the detected stents can be grouped and/or represented as a single segment for purposes of deriving assessments (e.g., assessments 324) and the stent(s) or stent segment(s) navigated through easily via a GUI such that assessments can be viewed and the placement of a stent as part of a post-PCI procedure evaluated to increase clinical outcomes.

The instructions 1208 transform the general, non-programmed machine 1200 into a particular machine 1200 programmed to carry out the described and illustrated functions in a specific manner. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while a single machine 1200 is illustrated, the term “machine” shall also be taken to include several ones of machine 1200 that individually or jointly execute the instructions 1208 to perform any one or more of the methodologies discussed herein.

The machine 1200 may include processors 1202, memory 1204, and I/O components 1242, which may be configured to communicate with each other such as via a bus 1244. In an example embodiment, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that may execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 may include a main memory 1212, a static memory 1214, and a storage unit 1216, both accessible to the processors 1202 such as via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor’s cache memory), or any suitable combination thereof, during execution thereof by the machine 1200.

The I/O components 1242 may include a wide variety of components to receive input, provide output, produce output, transmit information, exchange information, capture measurements, and so on. The specific I/O components 1242 that are included in a particular machine will depend on the type of machine. For example, portable machines such as mobile phones will likely include a touch input device or other such input mechanisms, while a headless server machine will likely not include such a touch input device. It will be appreciated that the I/O components 1242 may include many other components that are not shown in FIG. 12. The I/O components 1242 are grouped according to functionality merely for simplifying the following discussion and the grouping is in no way limiting. In various example embodiments, the I/O components 1242 may include output components 1228 and input components 1230. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1242 may include biometric components 1232, motion components 1234, environmental components 1236, or position components 1238, among a wide array of other components. For example, the biometric components 1232 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1242 may include communication components 1240 operable to couple the machine 1200 to a network 1220 or devices 1222 via a coupling 1224 and a coupling 1226, respectively. For example, the communication components 1240 may include a network interface component or another suitable device to interface with the network 1220. In further examples, the communication components 1240 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 1222 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

The various memories (i.e., memory 1204, main memory 1212, static memory 1214, and/or memory of the processors 1202) and/or storage unit 1216 may store one or more sets of instructions and data structures (e.g., software) embodying or utilized by any one or more of the methodologies or functions described herein. These instructions (e.g., the instructions 1208), when executed by processors 1202, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1220 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1220 or a portion of the network 1220 may include a wireless or cellular network, and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1208 may be transmitted or received over the network 1220 using a transmission medium via a network interface device (e.g., a network interface component included in the communication components 1240) and utilizing any one of several well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222. The terms “transmission medium” and “signal medium” mean the same thing and may be used interchangeably in this disclosure. The terms “transmission medium” and “signal medium” shall be taken to include any intangible medium that can store or carry the instructions 1208 for execution by the machine 1200 and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to "one embodiment" or "an embodiment" do not necessarily refer to the same embodiment, although they may. Unless the context clearly requires otherwise, throughout the description and the claims, the words "comprise," "comprising," and the like are to be construed in an inclusive sense as opposed to an exclusive or exhaustive sense; that is to say, in the sense of "including, but not limited to." Words using the singular or plural number also include the plural or singular number respectively, unless expressly limited to one or multiple ones. Additionally, the words "herein," "above," "below" and words of similar import, when used in this application, refer to this application as a whole and not to any portions of this application. When the claims use the word "or" in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. An intravascular image navigation system, comprising:
a processor; and
a memory storage device coupled to the processor, the memory storage device comprising instructions executable by the processor, which instructions when executed cause the intravascular image navigation system to:
receive a series of intravascular image (IVI) frames captured along a section of a cardiac artery of a patient where at least a first stent and a second stent are disposed in the section of the cardiac artery;
determine whether a distance between an edge of the first stent and an edge of the second stent is less than or equal to a threshold value, wherein the edge of the first stent is adjacent to the edge of the second stent; and
group the first stent and the second stent into a first stent segment if the distance between the edge of the first stent and the edge of the second stent is less than or equal to the threshold value; or
group the first stent into the first stent segment and the second stent into a second stent segment if the distance between the edge of the first stent and the edge of the second stent is not less than or equal to the threshold value, and
wherein the first stent segment and the second stent segment are stent segments of one or more stent segments.

2. The intravascular image navigation system of claim 1, wherein a third stent is disposed in the section of the cardiac artery, wherein the second stent is disposed between the first stent and the third stent, wherein the first stent and the second stent are grouped into the first stent segment, and wherein the memory storage device further comprising instructions executable by the processor, which instructions when executed cause the intravascular image navigation system to:
determine whether a distance between an edge of the second stent and an edge of the third stent is less than or equal to the threshold value, wherein the edge of the second stent is adjacent to the edge of the third stent;
group the third stent into the first stent segment if the distance between the edge of the second stent and the edge of the third stent is less than or equal to the threshold value; or
group the third stent into the second stent segment if the distance between the edge of the second stent and the edge of the third stent is not less than or equal to the threshold value.

3. The intravascular image navigation system of claim 1, wherein a third stent is disposed in the section of the cardiac artery, wherein the second stent is disposed between the first stent and the third stent, wherein the first stent is grouped into the first stent segment and the second stent is grouped into the second stent segment, and wherein the memory storage device further comprising instructions executable by the processor, which instructions when executed cause the intravascular image navigation system to:
determine whether a distance between an edge of the second stent and an edge of the third stent is less than or equal to the threshold value, wherein the edge of the second stent is adjacent to the edge of the third stent;
group the third stent into the second stent segment if the distance between the edge of the second stent and the edge of the third stent is less than or equal to the threshold value; or
group the third stent into a third stent segment if the distance between the edge of the second stent and the edge of the third stent is not less than or equal to the threshold value,
wherein the third stent segment is a stent segment of the one or more stent segments.

4. The intravascular image navigation system of claim 1, the memory storage device further comprising instructions executable by the processor, which instructions when executed cause the intravascular image navigation system to:
generate one or more graphical indications representing at least the first stent and the second stent, and the one or more stent segments; and
send one or more information elements to a display to cause the display to display the one or more graphical indications as part of a graphical user interface (GUI).

5. The intravascular image navigation system of claim 4, wherein the threshold value is a first threshold value, wherein the first stent and the second stent are grouped into the first stent segment, and wherein the memory storage device further comprising instructions executable by the processor, which instructions when executed cause the intravascular image navigation system to:
determine whether the distance between the edge of the first stent and the edge of the second stent is less than or equal to a second threshold value; and
wherein the first stent segment represented by the one or more graphical indications visually depicts the first stent and the second stent as one stent if the distance between the edge of the first stent and the edge of the second stent is less than or equal to the second threshold value, or
wherein the first stent segment represented by the one or more graphical indications visually depicts the first stent and the second stent as individual stents if the distance between the edge of the first stent and the edge of the second stent is not less than or equal to the second threshold value.

6. The intravascular image navigation system of claim 5, wherein the memory storage device further comprising instructions executable by the processor, which instructions when executed cause the intravascular image navigation system to:
designate the first stent segment as an active stent segment,
wherein the first stent segment represented by the one or more graphical indications is visually depicted as selected.

7. The intravascular image navigation system of claim 6, the memory storage device further comprising instructions executable by the processor, which instructions when executed cause the intravascular image navigation system to:
receive an indication to designate the second stent segment as the active stent segment,
regenerate the one or more graphical indications representing at least the first stent and the second stent, and the one or more stent segments; and
send one or more information elements to the display to cause the display to display the regenerated one or more graphical indications as part of the GUI,
wherein the second stent segment represented by the regenerated one or more graphical indications is visually depicted as selected.

8. The intravascular image navigation system of claim 7, wherein the indication to select the second stent segment as the active stent segment is received via the GUI.

9. The intravascular image navigation system of claim 6, the memory storage device further comprising instructions executable by the processor, which instructions when executed cause the intravascular image navigation system to:
determine whether the first stent segment includes the distal most complete stent; and
designate the first stent segment as the active stent segment if the first stent segment includes the distal most complete stent.

10. The intravascular image navigation system of claim 6, the memory storage device further comprising instructions executable by the processor, which instructions when executed cause the intravascular image navigation system to:
determine assessments based on an assessment process for the active stent segment,
wherein the one or more graphical indications further represent the assessments for the active stent segment.

11. The intravascular image navigation system of claim 5, wherein the second threshold distance is 2.0 millimeters (mm) or wherein the second threshold distance is between 1.5 millimeters (mm) and 2.5 mm.

12. The intravascular image navigation system of claim 1, wherein the threshold distance is 5.0 millimeters (mm) or wherein the threshold distance is between 3.5 millimeters (mm) and 6.5 mm.

13. The intravascular image navigation system of claim 1, wherein the series of IVI frames and intravascular ultrasound (IVUS) frames.

14. At least one non-transitory machine readable storage devices, comprising instructions that in response to being executed by a processor of an intravascular imaging (IVI) system cause the IVI system to:
receive a series of intravascular image (IVI) frames captured along a section of a cardiac artery of a patient where at least a first stent and a second stent are disposed in the section of the cardiac artery;
determine whether a distance between an edge of the first stent and an edge of the second stent is less than or equal to a threshold value, wherein the edge of the first stent is adjacent to the edge of the second stent; and
group the first stent and the second stent into a first stent segment if the distance between the edge of the first stent and the edge of the second stent is less than or equal to the threshold value; or
group the first stent into the first stent segment and the second stent into a second stent segment if the distance between the edge of the first stent and the edge of the second stent is not less than or equal to the threshold value, and
wherein the first stent segment and the second stent segment are stent segments of one or more stent segments.

15. The at least one non-transitory machine readable storage devices of claim 14, wherein a third stent is disposed in the section of the cardiac artery, wherein the second stent is disposed between the first stent and the third stent, wherein the first stent and the second stent are grouped into the first stent segment, and wherein the storage devices further comprise instructions that in response to being executed by the processor of the IVI system cause the IVI system to:
determine whether a distance between an edge of the second stent and an edge of the third stent is less than or equal to the threshold value, wherein the edge of the second stent is adjacent to the edge of the third stent;
group the third stent into the first stent segment if the distance between the edge of the second stent and the edge of the third stent is less than or equal to the threshold value; or
group the third stent into the second stent segment if the distance between the edge of the second stent and the edge of the third stent is not less than or equal to the threshold value.

16. The at least one non-transitory machine readable storage devices of claim 14, wherein a third stent is disposed in the section of the cardiac artery, wherein the second stent is disposed between the first stent and the third stent, wherein the first stent is grouped into the first stent segment and the second stent is grouped into the second stent segment, and wherein the storage devices further comprise instructions that in response to being executed by the processor of the IVI system cause the IVI system to:
determine whether a distance between an edge of the second stent and an edge of the third stent is less than or equal to the threshold value, wherein the edge of the second stent is adjacent to the edge of the third stent;
group the third stent into the second stent segment if the distance between the edge of the second stent and the edge of the third stent is less than or equal to the threshold value; or
group the third stent into a third stent segment if the distance between the edge of the second stent and the edge of the third stent is not less than or equal to the threshold value,
wherein the third stent segment is a stent segment of the one or more stent segments.

17. The at least one non-transitory machine readable storage devices of claim 14, further comprising instructions that in response to being executed by the processor of the IVI system cause the IVI system to:
generate one or more graphical indications representing at least the first stent and the second stent, and the one or more stent segments; and
send one or more information elements to a display to cause the display to display the one or more graphical indications as part of a graphical user interface (GUI).

18. A computer-implemented method for an intravascular image navigation system, comprising:
receiving, at a processor, a series of intravascular image (IVI) frames captured along a section of a cardiac artery of a patient where at least a first stent and a second stent are disposed in the section of the cardiac artery;
determining, by the processor, whether a distance between an edge of the first stent and an edge of the second stent is less than or equal to a threshold value, wherein the edge of the first stent is adjacent to the edge of the second stent; and
grouping, by the processor, the first stent and the second stent into a first stent segment if the distance between the edge of the first stent and the edge of the second stent is less than or equal to the threshold value; or
grouping, by the processor, the first stent into the first stent segment and the second stent into a second stent segment if the distance between the edge of the first stent and the edge of the second stent is not less than or equal to the threshold value, and
wherein the first stent segment and the second stent segment are stent segments of one or more stent segments.

19. The computer-implemented method of claim 18, further comprising:
generating, by the processor, one or more graphical indications representing at least the first stent and the second stent, and the one or more stent segments; and
sending, by the processor, one or more information elements to a display to cause the display to display the one or more graphical indications as part of a graphical user interface (GUI).

20. The computer-implemented method of claim 18, wherein the threshold value is a first threshold value, wherein the first stent and the second stent are grouped into the first stent segment, and wherein the method further comprises:
determining, by the processor, whether the distance between the edge of the first stent and the edge of the second stent is less than or equal to a second threshold value; and
wherein the first stent segment represented by the one or more graphical indications visually depicts the first stent and the second stent as one stent if the distance between the edge of the first stent and the edge of the second stent is less than or equal to the second threshold value, or
wherein the first stent segment represented by the one or more graphical indications visually depicts the first stent and the second stent as individual stents if the distance between the edge of the first stent and the edge of the second stent is not less than or equal to the second threshold value.
